(19) United States
(12) Patent Application Publication
(10) Pub. No.: US 2011/0185428 A1
(43) Pub. Date: Jul. 28, 2011

(54) METHOD AND SYSTEM FOR PROTECTION AGAINST UNKNOWN MALICIOUS ACTIVITIES OBSERVED BY APPLICATIONS DOWNLOADED FROM PRE-CLASSIFIED DOMAINS

(75) Inventor: Ahmed Said Sallam, Cupertino, CA (US)

(73) Assignee: McAfee, Inc., Santa Clara, CA (US)

(21) Appl. No.: 12/694,960

(22) Filed: Jan. 27, 2010

(51) Int. Cl. G06F 21/00; G06F 17/30; G06F 15/16

(52) U.S. Cl. 726/24; 707/769; 707/E17.108; 709/203

(57) ABSTRACT

A method for monitoring an application includes the steps of detecting the download of an application that originates from a website, identifying the domain of the website, and querying a database to select one or more behavioral analysis rules to apply to the application. The behavioral analysis rules are selected based upon an evaluation of the domain of the website. The evaluation of the domain of the website indicates a possible association with malware.

### TECHNICAL FIELD OF THE INVENTION

The present invention relates generally to computer security and malware protection and, more particularly, to a method and system for protecting against unknown malicious activities observed by applications downloaded from pre-classified domains.

### BACKGROUND

Anti-malware security applications may apply behavioral analysis rules designed to monitor a system or application memory for behavior indicative of malware. However, such applications do not consider the classification of domains. In addition, current methods of behavioral analysis monitoring can be memory and processor resource intensive. It is not feasible to apply all methods of behavioral analysis simultaneously. In addition, an anti-malware security application may not recognize the form of a malware application resident on a website until the application starts execution. Finally, an end user that is advised that a website may contain malware may decide to continue browsing the website.

### SUMMARY

A method for monitoring an application includes the steps of detecting the download of an application that originates from a website, identifying the domain of the website, and querying a database to select one or more behavioral analysis rules to apply to the application. The behavioral analysis rules are selected based upon an evaluation of the domain of the website. The evaluation of the domain of the website indicates a possible association with malware.

In a further embodiment, an article of manufacture includes a computer readable medium and computer-executable instructions. The computer-executable instructions are carried on the computer readable medium. The instructions are readable by a processor. The instructions, when read and executed, cause the process detect the download of an application that originates from a website, identify the domain of the website, and query a database to select one or more behavioral analysis rules to apply to the application. The behavioral analysis rules are selected based upon an evaluation of the website. The evaluation of the domain of the website indicates a possible association with malware.

In a further embodiment, a system for monitoring an application includes a database, a processor, and a system memory. The database includes one or more behavioral analysis rules. Each of the behavioral analysis rules is associated with the evaluation of one or more domains. The system memory contains instructions for execution by the processor to detect an application, identify the domain associated with the application, and query the database to select one or more behavioral analysis rules to apply to the application. The application is configured to be delivered to a recipient through a network. The application originates from a network entity. The network entity is associated with a domain. The behavioral analysis rules are selected based upon an evaluation of the domain of the website. The evaluation of the domain of the website indicates a possible association with malware.

### BRIEF DESCRIPTION OF THE DRAWINGS

For a more complete understanding of the present invention and its features and advantages, reference is now made to the following description, taken in conjunction with the accompanying drawings, in which:

FIG. 1 is an illustration of an example system for leveraging domain reputation and classification to apply behavior analysis rules to isolate malware;

FIG. 2 is an illustration of an example domain content classification database;

FIG. 3 is an illustration of an example executable classification database;

FIG. 4 is an illustration of an example domain security database;

FIG. 5A is an illustration of a portion of an example embodiment of a behavioral analysis database;

FIG. 5B is an illustration of another portion of example embodiment of a behavioral analysis database; and

FIG. 6 is an illustration of an example method for leveraging domain reputation and classification to apply behavior analysis rules to isolate malware.

### DETAILED DESCRIPTION

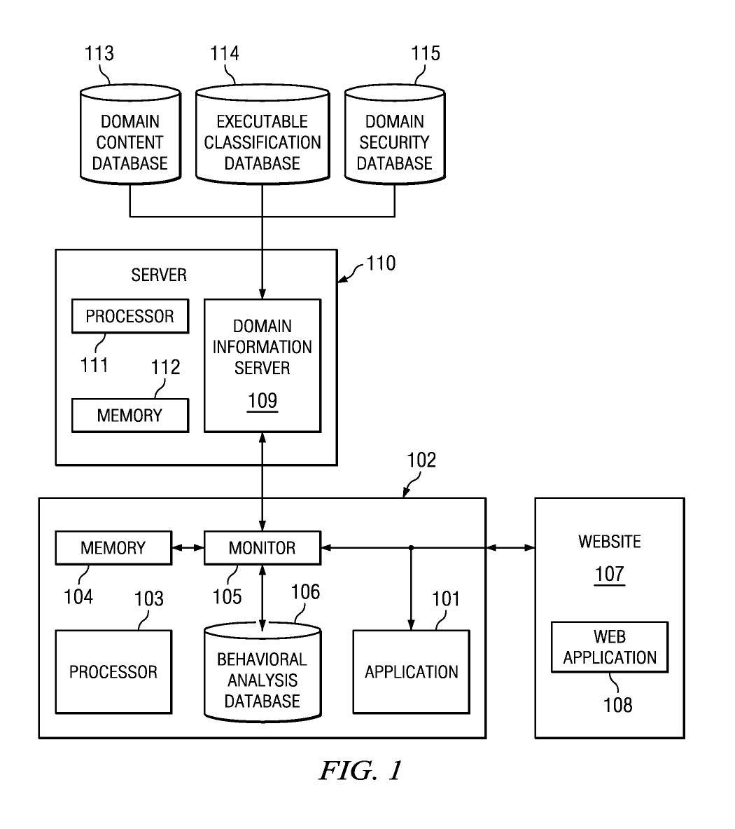

FIG. 1 is an illustration of an example system 100 for leveraging domain reputation and classification to apply behavior analysis rules to isolate malware. Malware may comprise digital content that produces unwanted activity. Malware may take many different forms, including, but not limited to, viruses, Trojans, worms, spyware, unsolicited electronic messages, phishing attempts, or any combination thereof.

System 100 may comprise an electronic device 102, a server 110, and a website 107. In system 100, application 101 may be running on electronic device 102. Application 101 may comprise a process, an executable, a shared library, a driver, a device driver, a run-time-engine, an operating system, object code, or any other binary instructions configured to be executed by electronic device 102. Electronic device 102 may comprise a computer, a personal data assistance, a phone, or any other device configurable to interpret and/or execute program instructions and/or process data. Electronic device 102 may be configured to interpret and/or execute program instructions and/or process data. Electronic device 102 may comprise a processor 103 coupled to a memory 104. In certain embodiments, processor 103 may comprise, for example a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104. Memory 104 may include any system, device, or apparatus configured to hold and/or house one or more memory modules. Each memory module may include any system, device or apparatus configured to retain program instructions and/or data for a period of time (e.g., computer-readable media). Application 101 may be executed by processor 103 while stored in memory 104. Electronic device 102 may have an operating system to perform typical operating system tasks such as memory management and running of applications.

Monitor 105 may be application also running on electronic device 102. Behavioral analysis rules database 106 may be a module on electronic device 102. Behavioral analysis rules database 106 and monitor 105 may be functionally coupled. Behavioral analysis rules database 106 may be configured to provide rules to monitor 105 for monitoring the running of an application, given suitable parameters. In one embodiment, monitor 105 may be configured to monitor application 101, the memory that application 101 may use, or any content that application 101 may be downloading from a network. Behavioral analysis rules database 106 may be implemented in any suitable way to adequately provide information to monitor 105 concerning rules for behavior analysis. In one embodiment, behavioral analysis rules database 106 may comprise a database. In one embodiment, behavioral analysis rules database 106 may comprise a functional library with data storage. In one embodiment, behavioral analysis rules database 106 may comprise a look-up table. In one embodiment, behavioral analysis rules database 106 may be a sub-module of monitor 105. In one embodiment, one or both of monitor 105 or behavioral analysis rules database 106 may reside and execute on a device such as one in a cloud computing server, separate from electronic device 102. In one embodiment, one or both of monitor 105 or behavioral analysis rules database 106 may reside on server 110. As described below, monitor 105 may be configured to use rules provided by behavioral analysis rules database 106 to monitor application operations, such as events and behaviors, match them against behavioral analysis rules database 106, and if an infection of malware is detected, prevent operation and repair the infection.

Website 107 may comprise a web application 108. Website 107 may also comprise files, multimedia, HTML pages, or any other digital information. Website 107 may have an associated domain. The associated domain may be a second-level or lower domain name, such as http://uspto.gov. The associated domain may be an IP address. Web application 108 may comprise a script, a shared library, source code, meta-code, object code, an executable, or a combination of these elements. Web application 108 may be configured to be downloaded to a machine that is accessing website 106. Web application 108 may be configured to be downloaded automatically, at user request, or as a result of a programmatic event. Website 107 and electronic device 102 may be communicatively coupled. In one embodiment, website 107 and electronic device 102 may communicate through hypertext transfer protocol. In one embodiment, website 107 and electronic device 102 may communicate through the use of packets.

A domain information server 109 may reside on server 110. Server 110 may be configured to interpret and/or execute program instructions and/or process data. Server 110 may comprise a processor 111 and a memory 112. In certain embodiments, processor 111 may comprise, for example a microprocessor, microcontroller, digital signal processor (DSP), application specific integrated circuit (ASIC), or any other digital or analog circuitry configured to interpret and/or execute program instructions and/or process data. In some embodiments, processor 111 may interpret and/or execute program instructions and/or process data stored in memory 112. Memory 112 may include any system, device, or apparatus configured to hold and/or house one or more memory modules. Each memory module may include any system, device or apparatus configured to retain program instructions and/or data for a period of time (e.g., computer-readable media). Server 110 may reside in a network location, communicatively coupled over the network to electronic device 102.

Domain information server 109 may be executed by processor 111 and stored in memory 112. Domain information server 109 may be communicatively coupled to monitor 105. In one embodiment, domain information server 109 and monitor 105 may communicate through Internet Protocol Suite. Domain information server 109 may be communicatively coupled to monitor 105 over a network such as the Internet, an intranet, or any combination of wide-area-networks, local-area-networks, or back-haul-networks. Domain information server 109 may be configured to send new or updated behavior analysis rules to monitor 105, which may then populate behavioral analysis rules database 106 with the new or updated rule. In one embodiment, behavioral analysis rules database 106 may reside on server 110. In such an embodiment, domain information server 109 may be functionally coupled to behavioral analysis rules database 106. In such an embodiment, monitor 105 may query domain information server 109 or behavioral analysis rules database 106, located on server 110, for behavior analysis rules for a particular domain.

One or more domain information databases 113, 114, 115 comprise information concerning a given domain. One or more domain information databases 113, 114, 115 may reside on server 110, or may be located on another device. Domain information databases 113, 114, 115 may be implemented in any manner suitable to provide storage and access to information concerning domains. Domain information databases 113, 114, 115 may be separate from each other, or may be combined into a fewer number of databases. Domain information databases 113, 114, 115 may be communicatively coupled to each other or to domain information server 109 over a network such as an intranet, a local-area-network, a wide-area-network, or any combination of these. Domain information databases 113, 114, 115 may be accessible by use of database queries from domain information server 109.

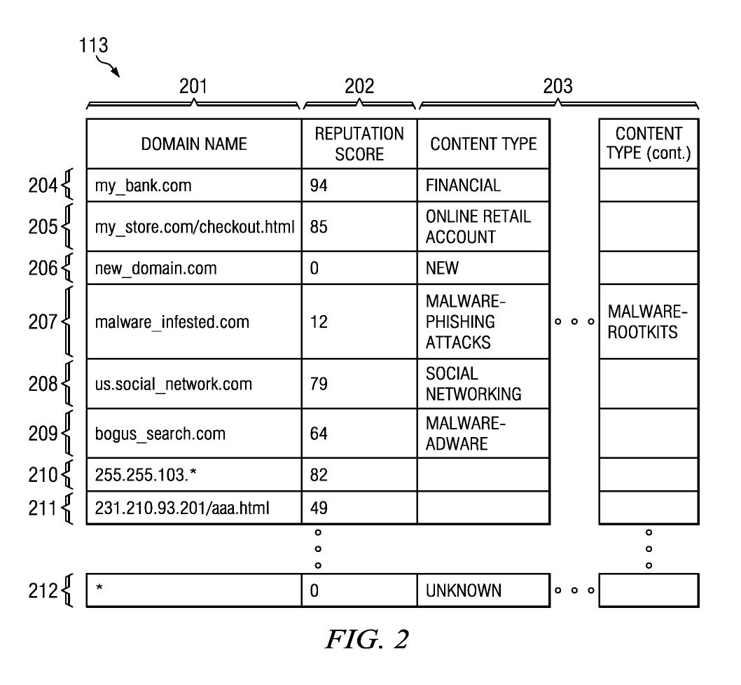

Domain content classification database 113 is one example of a domain information database. FIG. 2 is an illustration of an example of domain content classification database 113. The domain names, addresses, classifications, and categorizations used in FIG. 2 and all related drawings are completely fictional and provided for explanation purposes only. Domain content classification database 113 may comprise information associating a domain and the kinds of content that it contains. Domain content classification database 113 may contain any number of entries 204-212 for various domains. Domain content classification database 113 may comprise categorization or classification of the content of a particular domain. For example, each entry in domain content classification database 113 may contain a domain name field 201, a reputation score field 202, and/or more than one content type fields 203.

Domain name field 201 may comprise a domain name, such as “my_bank.com” 204, an Internet Protocol address with or without a wildcard matching all subdomains such as “255.255.103.*” 210, a domain with a specific universal resource locater address (“URL”) such as “my_store.com/checkout.html” 205, a domain with a specified subdomain such as “us.social_network.com” 207, or combinations of these, such as “231.210.93.201/aaa.html” 211. A default entry “*” 212 may be contained within domain content classification database 113, as an entry with default values in case a domain is not otherwise found.

Reputation score field 202 may comprise a reputation score for the domain indicated in domain name field 201. A reputation score may indicate a quantitative rating of the soundness of the domain in terms of a lack of unwanted or malicious behavior. Reputation score may be calculated and maintained by any acceptable means for determining the soundness of a domain in terms of a lack of unwanted or malicious behavior. Many factors may be used to determine reputation score, including: whether the domain is a source of spam messages; whether the domain is the destination of links contained in spam messages; whether the domain is the destination of links contained is electronic messages that in turn contain malware; whether the domain is linked to by other domains or servers that hose malware; the frequency and volume of electronic messages or traffic to or from the domain; the destination or source of electronic messages or traffic to or from the domain; the reputation of other domains hosted on the same servers or network as the domain; whether the domain's content is malware-free; whether the site host of the domain is deviating from known historical behavior; or whether the domain appears on a blacklist (indicating malicious sites) or a whitelist (indicating safe sites). The entries in reputation score field 202 may change as new information is used to populate domain content classification database 113. In one embodiment, the value of reputation score field 202 may range from 0 to 100, wherein 0 indicates the least degree of trustworthiness, and 100 indicates the greatest degree of trustworthiness of the domain. In one embodiment, a new entry into domain content classification database 113 without an existing reputation, such as entry “new_domain.com” 206 may be assigned a 0 for its reputation score. A default entry such as “*” may have a reputation score of 0.

Classification field 203 may comprise one or more fields containing an indicator for identifying the content of the domain. Classification field 203 may indicate generally or specifically malicious content of the domain. For example, in domain content classification database 113, “malwear_infested.com” 207 is classified as “Malware—Phishing Attacks” as well as “Malware—Rootkits,” indicating the site is known to contain phishing attack content as well as rootkit content. Classification field may indicate the kinds of neutral content of a domain. For example, “my_bank.com” 204 is classified as “Financial,” and “us.social_network.com” 208 is classified as “Social Networking” A default entry such as “*” may be classified as “Unknown.” Different values for classification field 203 may exist for any applicable category or type of malware.

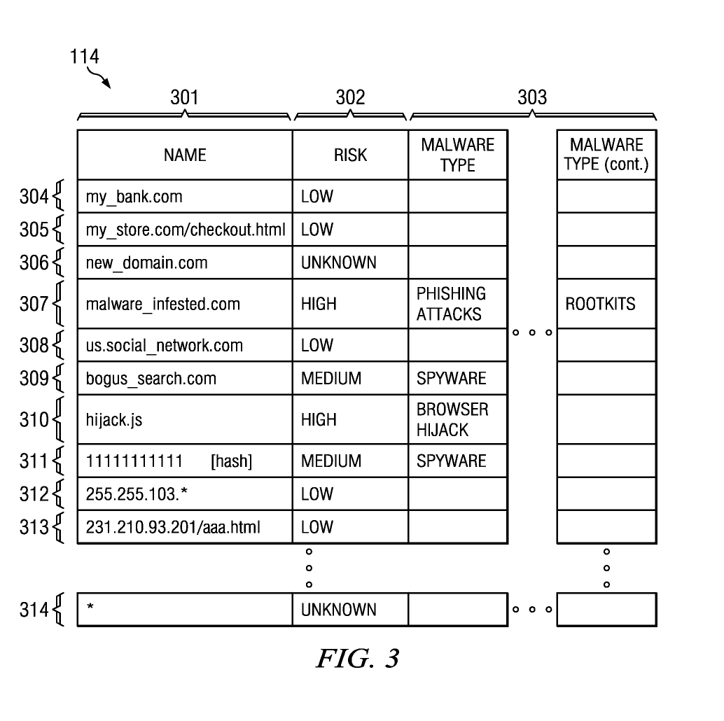

Executable classification database 114 is another example of a domain information database. FIG. 3 is an illustration of an example of executable classification database 113. The domain names, applications, classifications, and other fields used in FIG. 3 and all related drawings are completely fictional and provided for explanation purposes only. Executable classification database 114 may comprise information created by analyzing executables or applications on a given website or domain, to determine whether those executables are malware or not. Executable classification database 114 may comprise fields for an identifier 301, risk 302, and one or more fields for malware type 303. Executable classification database 114 may comprise any number of entries 304-314 for various domains, websites, executables, or other such identifiers.

Identifier field 301 may comprise a domain name, such as “my_bank.com” 304, an Internet Protocol address with or without a wildcard matching all subdomains such as “255.255.103.*” 312, an address with a URL such as “my_store.com/checkout.html” 305, a domain with a specified subdomain such as “us.social_network.com” 308, or combinations of these, such as “231.210.93.201/aaa.html” 313. Identifier field may 301 comprise an identification of an application, by a name such as “hijack.js” 310; or by a digital hash or signature, such as “1111111111” 311. The digital hash may computed by any suitable means to reverse attempts to disguise the nature of an application by changing its size, name, or other characteristics. In one embodiment, the digital hash algorithms employed by standard anti-malware software may be used to compute the digital hash or signature of the application. A default entry “*” 314 may be contained within executable classification database 114, as an entry with default values in case an identifier is not otherwise found.

Executable classification database 114 may assign a risk 302 to executables, or to a given website or domain associated with. The risk 302 may be determined by analyzing the executable and determining its potential effects. In one embodiment, risk 302 may be qualitative. In one embodiment, risk 302 may have values of low, indicating very low or no risk issues; medium, indicating minor risk issues or annoyances; high, indicating serious risk issues; and unknown, indicating that the executable or domain is not yet known. For example, “my_bank.com” 304 may be a website not known for hosting malware, and may be assigned a “low” risk. “1111111111” 311 may be an application that will add pop-up windows to a software browser, and thus be assigned a “medium” risk. “malware_infested.com” may be a website known for hosting particularly bad kinds malware, and may be assigned a “high” risk. “new_domain.com” may be a website not yet investigated, and may be assigned “unknown” risk. In one embodiment, all entries with “unknown” risks may be assumed to equivalent to “high” risk entries.

Executable classification database 114 may provide information as to the malware type 303 associated with a domain or application. Malware type 303 may indicate generally or specifically malicious content of the application or applications associated with the domain. For example, “malware_infested.com” may be associated with both “Phishing attack” applications and “Rootkit” applications. An individual application, such as “hijack.js” may be known to be malware for hijacking a web browser, and thus be assigned a “Browser Hijack” type. Values for malware type 303 may exist for any applicable category or type of malware.

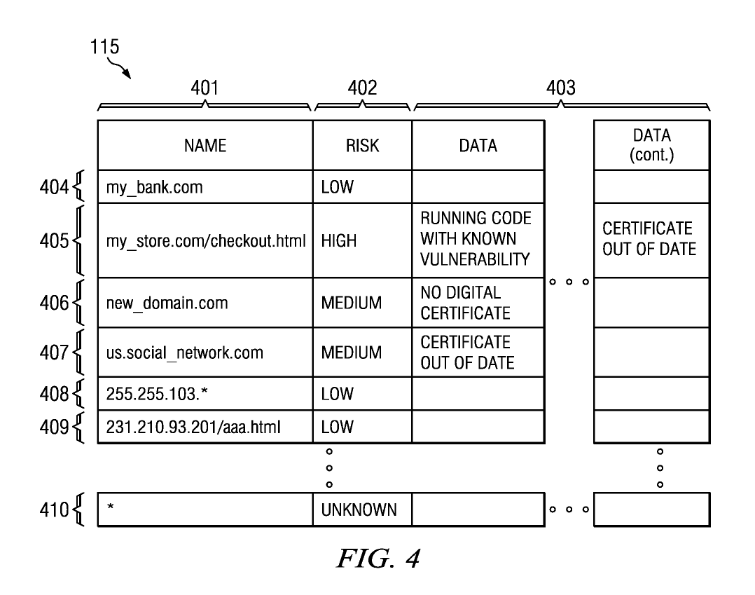

Domain security database 115 is yet another example of a domain information database. FIG. 4 is an illustration of an example domain security database 115. The domain names, classifications, and other fields used in FIG. 4 and all related drawings are completely fictional and provided for explanation purposes only. Domain security database 115 may comprise information associating a domain and the security of the servers running on the domain. Domain security database 115 may comprise as many entries 404-410 necessary to suitably cover the range of domains for which domain security is known. Domain security database 115 may comprise a domain name field 401, and risk field 402, and a data field 403.

Domain name field 401 may comprise a domain name, such as “my_bank.com” 404, an Internet Protocol address with or without a wildcard matching all subdomains such as “255.255.103.*” 408, a domain with a specific URL such as “my_store.com/checkout.html” 405, a domain with a specified subdomain such as “us.social_network.com” 407, or combinations of these, such as “231.210.93.201/aaa.html” 409. A default entry “*” 410 may be contained within domain security database 115, as an entry with default values in case a domain is not otherwise found.

Risk field 402 may comprise an assessment or classification of the security of a server associated with a domain. For example, domain security database 115 may assess servers associated with a domain based upon factors such as whether: the server's software or code is out of date (and thus possibly containing security holes); the server employs known security techniques or devices; whether the server has an up-to-date digital certificate; whether the server utilizes encryption methods; or whether the server contains known vulnerabilities (such as vulnerable software or devices). In one embodiment, domain security database 115 may classify domains as secure or insecure. In one embodiment, domain security database 115 may associate a quantized risk factor with a domain. In one embodiment, domain security database 115 may classify a domain with a relative qualitative security score, such as high, medium, low, or unknown. For example, “mystore.com/checkout.html” 405 be running on a server utilizing software with a known vulnerability allowing malware to operate on the website, as well as an out-of-date digital certificate. Accordingly, “mystore.com/checkout.html” 405 may be associated with a high server security risk. In another example, “us.social_network.com” 406 may be running on a server with no digital certificate. Accordingly, “mystore.com/checkout.html” 406 may be associated with a medium server security risk. In yet another example, “my_bank.com” 404 may be running on a server with no observed security risks. Accordingly, “my_bank.com” 404 may be associated with a low server security risk. A default entry, such as “*” 410, or another entry for which information is not available, may be associated with an unknown sever security risk. In one embodiment, entries associated with an unknown server security risk, such as “*” 410, may be treated as equivalents to entries with high server security risk, such as “my_store.com/checkout.html.”

Data field 403 may comprise one or more fields for storing information associated with the risk field 402. Information in data field 403 may comprise identifiers indicating the security risks associated with the servers running the domain of a given entry. For example, the information in data field 403 may specify that the server is running software with a known vulnerability, the identity of the vulnerability, the digital certificate status, or any other suitable information.

Turning back to FIG. 1, the rules contained within behavioral analysis database 106 may be based on information, including evaluations of domains and applications, contained in domain information databases 113, 114, 115.

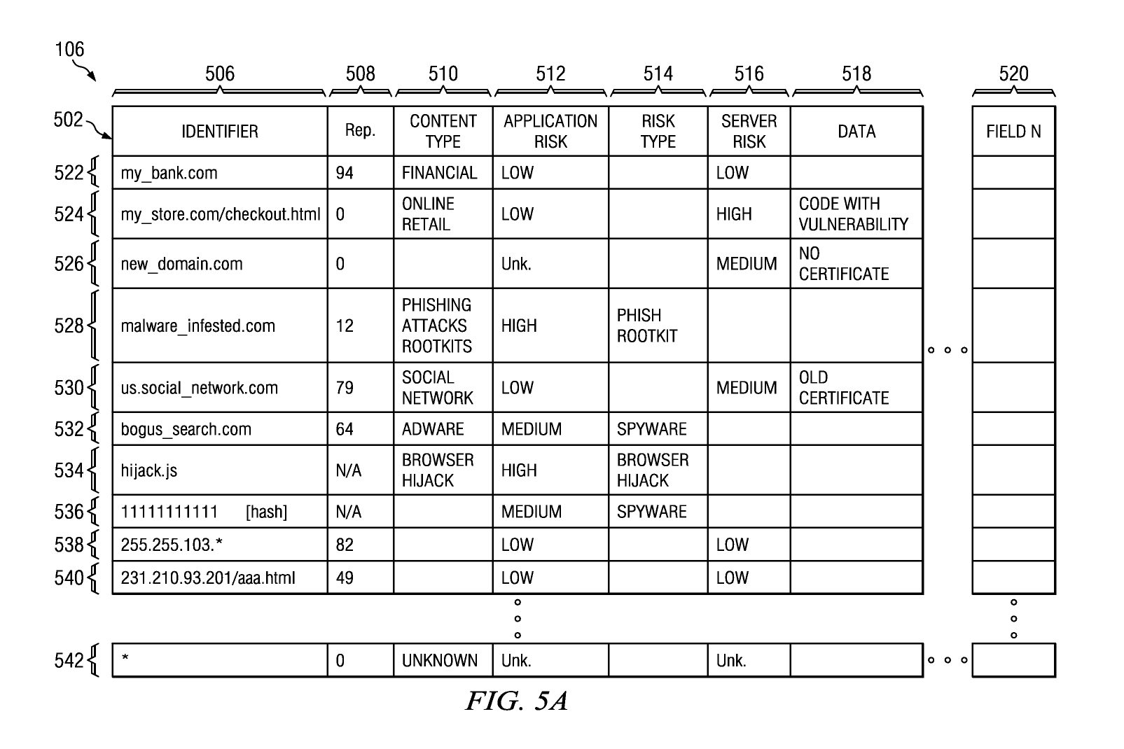

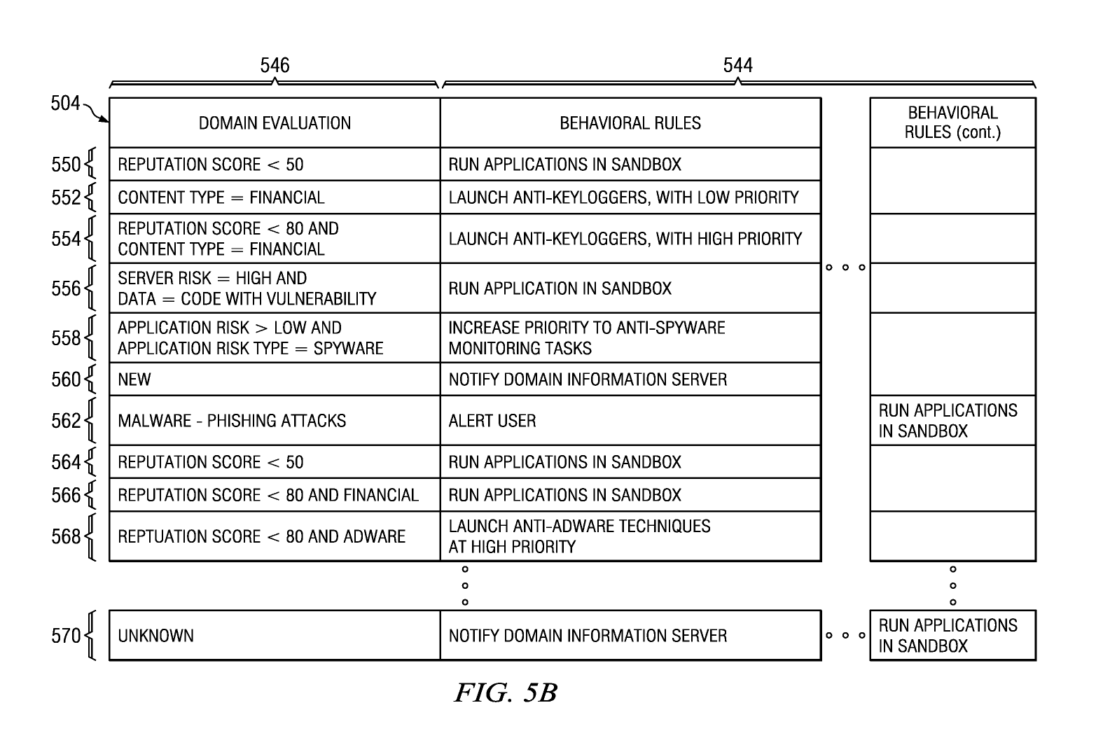

FIGS. 5A and 5B illustrate an example embodiment of behavioral analysis database 106. The names, addresses, classifications, categorizations, evaluations, and rules used in FIGS. 5A and 5B and all related drawings are completely fictional and provided for explanation purposes only. Behavioral analysis database may comprise a domain evaluation lookup 502 and a behavioral rule table 504. Domain evaluation lookup 502 and behavioral rule table may be collocated within the same or related database or data structures. Domain evaluation lookup 502 and behavioral rule table 504 may be coupled together. Domain evaluation lookup 502 and behavioral rule table may both be configured to be operable by a third module, application, or data structure. In one embodiment, domain evaluation lookup 502 and behavioral rule table may both be configured to both be operable by monitor 105. In one embodiment, domain evaluation lookup 502 and behavioral rule table may both be configured to both be operable by domain information server 109.

Domain evaluation lookup 502 may be configured to yield one or more evaluations of a domain or application, given the identity of the domain or application. Domain evaluation lookup 502 may be coupled to behavioral rule table 504. Domain evaluation lookup 502 may comprise information 508-520 associated with a domain or application. The evaluation yielded by domain evaluation lookup 502 may be associated with information 508-520. A domain associated with information 508-520 may comprise or be represented by a domain name, internet protocol address, a range of internet protocol addresses, a sub-domain, a URL, or any other suitable means of identifying a domain. An application associated with information 508-520 may comprise a script, a shared library, source code, meta-code, object code, an executable, or a combination of these elements. An application associated with information 508-520 may be represented by a digital hash or signature.

The information 508-520 in domain evaluation lookup 502 may comprise evaluations of the associated domain or application. The individual fields of information 508-520 may comprise replications, summaries, derivations, or results of operations based off of various data fields of domain information databases 113, 114, 115. For example, reputation 508 may be associated with reputation score field 202; content type may be associated with classification field 203; application risk 512 may be associated with risk 302; risk type 514 may be associated with malware type 303; server risk 516 may be associated with risk field 402; and data 518 may be associated with data field 403. Domain evaluation lookup 502 may comprise additional information fields, such as FieldN 520, which may not have corresponding fields in domain information databases 113, 114, 115. Domain evaluation lookup 502 may comprise in quantity or kind as many information fields as necessary to suitably provide an evaluation of a domain or application.

Domain evaluation lookup 502 may comprise one or more entries 522-542, corresponding to a domain, group of domains, an internet address, a range of internet addresses, a subdomain, a URL, or an application. The individual entries 522-542 may comprise replications, summaries, derivations, or results of operations based off of various entries in domain information databases 113, 114, 115. Domain evaluation lookup 502 may comprise as many entries 522-542 as necessary to suitably provide an evaluation of a given domain.

In one embodiment, domain evaluation lookup 502 may be contained within behavioral analysis database 106, and may be configured to be used in conjunction with behavioral rule table 504. Given a domain, address, or application, domain evaluation lookup 502 may be configured to return one or more evaluations of the domain, address, or application, in the form of the contents of information 508-520 for a given entry.

In one embodiment, domain evaluation lookup 502 may comprise a database separate from behavioral analysis database 106. In such an embodiment, domain evaluation lookup may not reside on electronic device 102. In such an embodiment, domain evaluation lookup 502 may reside on server 110. In such an embodiment, domain evaluation lookup 502 may be configured to be queried over a network by monitor 105. In such an embodiment, domain information server 109 may comprise domain evaluation lookup 502. In such an embodiment, domain information server 109 and monitor 105 may be configured to communicate to exchange queries and information for evaluations of a domain.

In one embodiment, domain evaluation lookup 502 may comprise links to domain information databases 113, 114, 115. In such an embodiment, domain information databases 113, 114, 115 may be queried for their fields corresponding to a domain.

In one embodiment, domain evaluation lookup may be implemented by an application, process, or server configured to respond to queries for information comprising evaluations of a domain. In such an embodiment, the application, process, or server may reside on electronic device 102 or server 110. In such an embodiment, domain information server 109 may comprise the application, process, or server.

In one embodiment, domain evaluation lookup 502 may be contained within behavioral analysis database 106, and may be configured to be used in conjunction with behavioral rule table 504.

Behavioral rule table 504 may comprise behavioral rules 544 for monitoring the execution of an application given a domain evaluation 546. Behavioral rule table 504 may be configured to be used in conjunction with a given domain evaluation, such as that yielded by domain evaluation lookup 502, to yield one or more behavioral rules given a domain. Behavioral rule table 504 may be implemented in any suitable manner for yielding one or more behavioral rules given a domain, such as a database, data structure, table, software module, or another application.

A domain evaluation 546 may be comprised of an evaluation associated with information contained in a domain information database, such as domain information databases 113, 114, 115. A domain evaluation 546 may comprise one or more pieces of evaluation information. A domain evaluation 546 may comprise an evaluation from any of the fields comprising information 508-520. A domain evaluation 546 may comprise conditions or thresholds associated with evaluation information. For example, rule 554 may be employed when a domain has a reputation score less than 80, and contains content that is financial in nature.

Behavioral rules 544 may comprise instructions, scripts, batch files, or other information or mechanisms indicating an action to be taken to monitor the execution of an application. In one embodiment, monitor 105 may be configured to carry out behavioral rules 544. Behavioral rules 544 may be associated with the domain evaluation 546 by which they were selected. For example, in rule 552, a domain evaluation that the domain contains financial content may yield a behavioral rule that anti-keyloggers are activated.

Returning to FIG. 1, the new or updated behavioral rules that domain information server 109 may be configured to monitor 105 may be derived from information contained in domain information databases 113, 114, 115. Certain aspects of behavioral analysis database 106 may be automatically generated based on new information within domain information databases 113, 114, 115. For example, if a new entry with reputation information and content type is populated within domain content classification database 113, the information may then be available in behavioral analysis database 106. In one embodiment, monitor 105 or domain information server 109 may be configured to associate the new entry in domain content classification database 113 with a new entry in behavioral analysis database 105. In another example, in an existing entry with reputation and content type is populated with new information within domain content classification database 113, the information may then be available in behavioral analysis database 105. In one embodiment, monitor 105 or domain information server 109 may be configured to associate the updated entry in domain content classification database 113 with an updated entry in behavioral analysis database 106.

In operation, behavioral analysis rules may be created at domain information server 109 from the association of information from domain information databases 113, 114, 115 with possible behavioral analysis actions. Behavioral analysis rules may be created from a user inputting the behavioral analysis rules. Behavioral analysis rules may be created from a monitor program 105 that has discovered a malware association with a particular domain. Domain information server 109 may transmit behavior analysis rules to monitor 105, which may store the behavior analysis rules in behavioral analysis rules database 106. Behavioral analysis rules may be created by associating an evaluation to a rule, identifying domain categories, classification, or other information with actions to be applied when accessing content at such domains. The transmission of the rules may occur at the initiation of either domain information server 109 or monitor 105, or at such times as start-up of monitor 105 or a regularly scheduled time.

An application 101 running on electronic device 102 may attempt to access a website 107 over the Internet. Website 107 may contain an application 108 for download to electronic device 102. Monitor 105 observes the domain of the website 107 and/or the identity of the application 108 for download to electronic device 102. In one embodiment, application 101 running on electronic device 102 may attempt to access an electronic message, such as an instant message or an e-mail. In such an embodiment, the electronic message may be residing somewhere other than a website, such as in the memory 104 of electronic device. In such an embodiment, the electronic message may originate from a domain, contain an application 108, and the operation would proceed as would operation for accessing a website. Monitor 105 may observe the domain or application 108 to be downloaded preemptively, as application 101 attempts to access website 107 or application 108 to be downloaded, of after application 101 has accessed website 107 or application 108 to be downloaded. Monitor 105 may look up the domain of the website 107 or the application 108 to be downloaded in behavioral analysis rules database 106. Behavioral analysis rules database 106 may return a rule based upon the identity of the website 107 or the application 108 to be downloaded. The rule may indicate to monitor 105 that a particular behavior analysis action should be taken, such as monitoring a port or a portion of memory 104 of the electronic device 102. In one embodiment, such monitoring techniques may be memory and resource intensive, and it may be undesirable to continuously employ such monitoring techniques. Consequently, rules may be given a higher or lower priority based upon behavioral analysis rules database 106, in order to provide an adequate balance of system performance and system security. Consequently, monitor 105 may apply higher priority rules at the expense of lower priority rules, while conserving the remainder of system resources for the normal operations of the system.

Many different possible behavioral analysis rules may be applied by monitor 105, as illustrated in FIGS. 5A and 5B. Behavioral analysis database 106 may comprise, and monitor 105 may apply, as many different behavioral rules 550-570 as necessary to suitably address domains encountered by system 100.

In one embodiment, a web application 108 or a similarly downloaded file from the domain will be run in a “sandbox,” or a portion of electronic device 102 that is secure enough that a malicious program may be operated without fear of adverse affects to the rest of the system. For example, if the server of a domain of website 107 such as “my_store.com/checkout.html” 530 is insecure, behavioral analysis database 106 will return a rule such as rule 556, specifying that a file downloaded from the domain will be run in a sandbox, or in any portion of electronic device 102 that is secure enough that a malicious program may be operated without fear of adverse affects to the rest of the system. After web application 108 or a similarly downloaded file is proven to be free from malicious effects, it may be moved from the sandbox.

In one embodiment, if the domain of website 107 is classified as associated with a particular type of malware, then monitor 105 may employ monitoring techniques associated with that particular type of malware to observe the behaviors of system, include memory 104 and application 101. For example, if an application such as “1111111111” 536 is downloaded from a website 107 with a medium risk, behavioral analysis database 106 may return a rule such as rule 558 for monitor 105 to assign a higher priority to anti-spyware behavioral analysis rules, such as monitoring operating system registers typically changed by spyware. In one embodiment, monitor 105 need not know anything about a given application on website 107; the knowledge of the domain of website 107 may be sufficient to apply a protective rule against malware incorporated in website 107 or its applications. To reuse the previous example, if application “1111111111” was unknown to system 100, comprised spyware, but resided on a website such as “bogus_search.com” 532 with a medium risk of hosting spyware, behavioral analysis database 106 may also return a rule such as rule 558 for monitor 105 to assign a higher priority to anti-spyware behavioral analysis rules.

In one embodiment, monitor 105 may notify users of application 101 that the site contains dangerous malware, and allow the user to continue or abandon the operation. For example, a user of application 101 may access a site such as “malware_infested.com” 528 known to host malware for phishing attacks, which would cause behavioral analysis database to yield rule 562, which would alert a user. If a user continued the operation, rule 562 may also notify monitor 105 to subsequently run the application in a sandbox.

Information from different domain information databases 113, 114, 115 may be combined in a behavioral analysis rule. In one embodiment, the domain of a website 107 such as “my_bank.com” 522 may contain sensitive content, such as financial information. In such a case, behavioral analysis rules database 106 may yield a rule 552 to indicate to monitor 105 to employ, for example, anti-keyloggers and other anti-data theft rules at a low priority to prevent applications on website 107 from stealing end use financial identity and information. However, if the domain of website 107 were of financial data, and had a reputation score less than a particular threshold such as 80 (perhaps, behavioral analysis rules database 106 may yield a rule 554 to run, for example, the same behavioral monitoring techniques at a higher priority.

Monitor 105 may clean application 101 or other objects in electronic device 102 through any suitable method for elimination of malware, once the malware has been identified. For example, execution of malware may be blocked, the malware or its effects quarantined, the malware or infected objects may be removed, etc. Monitor 105 may send an alert or message to a user or administrator of electronic device 102 requesting permission to clean application 101 or other objects in electronic device 102.

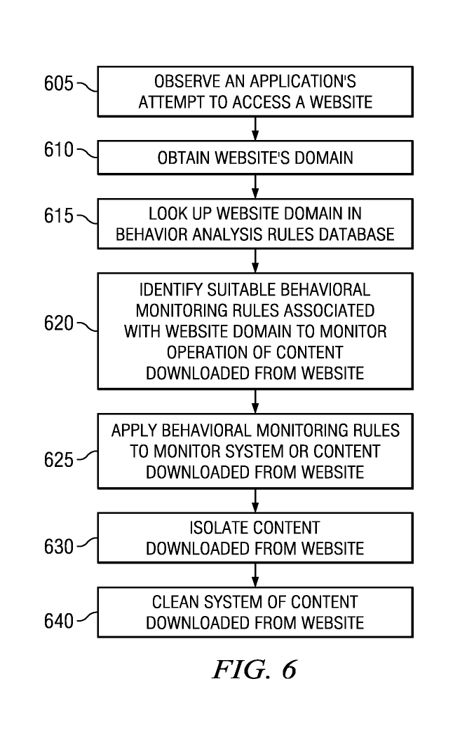

FIG. 6 illustrates an example method 600 for leveraging domain reputation and classification to apply behavior analysis rules to isolate malware. In step 605, an attempt by an application to access a website, an application or other content on a website, or from an electronic message, may be observed. The observation may happen simultaneously with the access, or after the attempt. In step 610, the website's domain may be obtained. In one embodiment, the domain of the source of the application, or the domain of the source of the electronic message may be obtained. The domain may take the form of a top-level domain, a subdomain, a domain name, a URL, an individual internet address, or a range of internet addresses. In step 615, the website domain may be looked up in a behavior analysis rules database. The behavior rules database may map a domain with behavioral monitoring rules that should be applied to monitor applications from the domain, and systems accessing the domain. Mapping the domain with behavioral monitoring rules may comprise accessing evaluation information about the domain. The evaluation information may take many forms of evaluating the risk, content, or other nature of the domain in relation to malware. In step 620, the suitable behavioral monitoring rules associated with the website domain may be identified based on the evaluation of the domain. The rules may comprise instructions, applications, scripts, or other information indicating what behavior of the system or application needs to be monitored. In step 625, the behavioral monitoring rules may be applied to monitor the executing or downloading the content from the website or electronic message, looking for behaviors associated with malware. In one embodiment, multiple behavioral monitor rules may be applied. In one embodiment, different priorities may be given to different behavioral monitoring rules. In step 630, the content downloaded from the website or electronic message, including applications, may be optionally isolated and executed in a secure portion of the system to contain malicious effects of the content. This step may follow an indication to a user of application warning of the malicious effects of the content. In step 635, the system may be cleaned of content such as malware that was downloaded and/or executed.

Method 600 may be implemented using the system of FIGS. 1-5, or any other system operable to implement method 600. In certain embodiments, method 600 may be implemented partially or fully in software embodied in computer-readable media.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, and other electromagnetic and/or optical carriers; and/or any combination of the foregoing.

Although the present disclosure has been described in detail, it should be understood that various changes, substitutions, and alterations can be made hereto without departing from the spirit and the scope of the disclosure as defined by the appended claims.

What is claimed is:

1. A method of monitoring an application, comprising the steps of:
detecting the download of an application, the application originating from a website;
identifying the domain of the website; and
querying a database to select one or more behavioral analysis rules to apply to the application, wherein:
the behavioral analysis rules selected are based upon an evaluation of the domain of the website; and
the evaluation of the domain of the website indicates a possible association with malware.

2. The method of claim 1, further comprising the steps of:
allowing execution of the application; and
applying the selected one or more behavioral analysis rules to monitor the execution of the application.

3. The method of claim 1, wherein the database resides on a server.

4. The method of claim 3, further comprising the steps of sending the selected one or more behavioral analysis rules from the server to a client.

5. The method of claim 1, wherein the evaluation comprises categorizing the domain according to a security-related characteristic.

6. The method of claim 1, wherein the evaluation comprises assigning a priority to the domain, the priority assigned according to a security-related characteristic.

7. The method of claim 1, wherein the evaluation comprises a determination of the security of the domain.

8. The method of claim 7, further comprising the step of:
if the domain is not secure, then allowing execution the application in a secure environment before executing the application in a target machine's application memory.

9. The method of claim 1, wherein the evaluation comprises evaluating the domain as associated with a particular kind of malware.

10. The method of claim 9, further comprising the step of if the site is known to be associated with a particular kind of malware, then assigning higher priority to behavioral analysis rules relating to the particular kind of malware.

11. The method of claim 1, wherein the evaluation comprises evaluating content of the domain.

12. The method of claim 11, further comprising the step of assigning higher priority to behavioral analysis rules comprising anti-data theft rules, wherein the anti-data theft rules are associated with the content of the domain.

13. The method of claim 1, further comprising the step of repairing an infection of malware related to the application.

14. The method of claim 1, further comprising the steps of:
selecting and applying a behavioral analysis rule for notifying an end user that the application may be harmful; and
if the end user does not terminate the execution of the application, then allowing execution the application in a secure environment before executing the application in a target machine's application memory.

15. An article of manufacture, comprising:
a computer readable medium; and
computer-executable instructions carried on the computer readable medium, the instructions readable by a processor, the instructions, when read and executed, for causing the processor to:
detect the download of an application, the application originating from a website;
identify the domain of the website; and
query a database to select one or more behavioral analysis rules to apply to the application, wherein:
the behavioral analysis rules selected are based upon an evaluation of the domain of the website; and
the evaluation of the domain of the website indicates a possible association with malware.

16. The article of claim 15, wherein the processor is further caused to:
allow execution of the application; and
apply the selected one or more behavioral analysis rules to monitor the execution of the application.

17. The article of claim 15, wherein:
the database resides on a server; and
the processor is further caused to:
send the domain to the server; and
receive the selected one or more behavioral analysis rules from the server.

18. The article of claim 15, wherein the evaluation comprises a categorization of the domain according to a security-related characteristic.

19. The article of claim 15, wherein the evaluation comprises a priority assigned to the domain, the priority assigned according to a security-related characteristic.

20. The article of claim 15, wherein the evaluation comprises a determination of the security of the domain.

21. The article of claim 20, wherein if the processor is further caused to:
if the domain is not secure, allow execution of the application in a secure environment before executing the application in a target machine's application memory.

22. The article of claim 15, wherein the evaluation comprises an association of the domain with a particular kind of malware.

23. The article of claim 22, wherein the processor is further caused to:
if the site is associated with a particular kind of malware, then assign higher priority to behavioral analysis rules relating to the particular kind of malware.

24. The article of claim 15, wherein the evaluation comprises content of the domain.

25. The article of claim 24, wherein the processor is further caused to assign higher priority to behavioral analysis rules comprising anti-data theft rules, wherein the anti-data theft rules are associated with the content of the domain.

26. The article of claim 15, wherein the processor is further caused to repair an infection of malware related to the application.

27. The article of claim 15, wherein the processor is further caused to:
select and apply a behavioral analysis rule for notifying an end user that the application may be harmful; and
if the end user does not terminate the execution of the application, allow execution of the application in a secure environment before executing the application on a target machine.

28. A system for monitoring an application, comprising:
a database, the database comprising one or more behavioral analysis rules, each of the one or more behavioral analysis rules associated the evaluation of one or more domains;
a processor; and
a system memory, the system memory containing instructions for execution by the processor to:
detect an application, wherein the application:
is configured to be delivered to a recipient through a network; and
originates from a network entity, the network entity associated with a domain;
identify the domain associated with the application; and
query the database to select one or more behavioral analysis rules to apply to the application, wherein:
the behavioral analysis rules are selected based upon an evaluation of the domain of the website; and
the evaluation of the domain of the website indicates a possible association with malware.

29. The system of claim 28, wherein the system memory further contains instructions for execution by the processor to:
allow execution of the application; and
apply the selected one or more behavioral analysis rules to monitor the execution of the application.

30. The system of claim 28, wherein:
the database resides on a server; and
the system memory further contains instructions for execution by the processor to:
send the domain to the server; and
receive the selected one or more behavioral analysis rules from the server.

31. The system of claim 28, wherein the evaluation comprises a categorization of the domain according to a security-related characteristic.

32. The system of claim 28, wherein the evaluation comprises a priority assigned to the domain, the priority assigned according to a security-related characteristic.

33. The system of claim 28, wherein the evaluation comprises a determination of the security of the domain.

34. The system of claim 33, wherein the system memory further contains instructions for execution by the processor to:
if the domain is not secure, execute the application in a secure environment before executing the application on a target machine.

35. The system of claim 28, wherein the evaluation comprises an association of the domain with a particular kind of malware.

36. The system of claim 35, wherein the system memory further contains instructions for execution by the processor to:
if the site is associated with a particular kind of malware, then assign higher priority to behavioral analysis rules relating to the particular kind of malware.

37. The system of claim 28, wherein the evaluation comprises content of the domain.

38. The system of claim 37, wherein the system memory further contains instructions for execution by the processor to assign higher priority to behavioral analysis rules comprising anti-data theft rules, wherein the anti-data theft rules are associated with the content of the domain.

39. The system of claim 28, wherein the electronic device is further configured to repair an infection of malware related to the application.

40. The system of claim 28, wherein the system memory further contains instructions for execution by the processor to:
select and apply a behavioral analysis rule for notifying an end user that the application may be harmful; and
if the end user does not terminate execution of the application, execute the application in a secure environment before executing the application on a target machine.
